(19) United States
(12) Patent Application Publication
(10) Pub. No.: US 2025/0096662 A1
(43) Pub. Date: Mar. 20, 2025

(54) OPTICAL ELEMENT DRIVING MECHANISM

(71) Applicant: TDK TAIWAN CORP., Taoyuan City (TW)

(72) Inventors: Po-Xiang ZHUANG, Taoyuan City (TW); Jui-Ta CHIEN, Taoyuan City (TW); Wei-Jhe SHEN, Taoyuan City (TW); Yi-Ho CHEN, Taoyuan City (TW); Shou-Jen LIU, Taoyuan City (TW); Kun-Shih LIN, Taoyuan City (TW)

(21) Appl. No.: 18/884,360

(22) Filed: Sep. 13, 2024

Related U.S. Application Data
(60) Provisional application No. 63/583,067, filed on Sep. 15, 2023.

(51) Int. Cl. H02K 41/02; H02K 7/14; H02K 11/215

(52) U.S. Cl. CPC H02K 41/02; H02K 7/14; H02K 11/215

(57) ABSTRACT

An optical element driving mechanism is provided. The optical element driving mechanism includes a movable part, a fixed part, and a driving assembly. The movable part connects an optical element. The movable part is movable relative to the fixed part. The driving assembly drives the optical element to move relative to the fixed part.

### CROSS REFERENCE TO RELATED APPLICATIONS

This application claims the benefit of U.S. Provisional Application No. 63/583,067, filed 2023 Sep. 15, the entirety of which is incorporated by reference herein.

### BACKGROUND OF THE INVENTION

### Field of the Invention

The present invention relates to an optical driving mechanism, and, in particular, to relates to an optical element driving mechanism having a driving assembly including a plurality of magnetic elements and coils.

### Description of the Related Art

With the development of science and technology, many electronic devices (such as notebook computers, smart-phones and digital cameras) now have the function of taking pictures or recording videos. The use of these electronic devices is becoming more and more common. In addition to developing better and more stable optical quality, the designs are also moving towards convenient and thin to provide users with more choice.

In view of this, there is a need for an optical element driving mechanism that allows the optical photography focal length to be adjusted to adapt to different photographic conditions. At the same time, it may reduce operational errors caused by interference with magnetic elements during operation, stabilize the internal structure, and provide optical quality that is better and more stable.

### BRIEF SUMMARY OF THE INVENTION

The term embodiment and like terms are intended to refer broadly to all of the subject matter of this disclosure and the claims below. Statements containing these terms should be understood not to limit the subject matter described herein or to limit the meaning or scope of the claims below. Embodiments of the present disclosure covered herein are defined by the claims below, not this summary. This summary is a high-level overview of various aspects of the disclosure and introduces some of the concepts that are further described in the Detailed Description section below. This summary is not intended to identify key or essential features of the claimed subject matter. This summary is also not intended to be used in isolation to determine the scope of the claimed subject matter. The subject matter should be understood by reference to appropriate portions of the entire specification of this disclosure, any or all drawings and each claim.

According to certain aspects of the present disclosure, an optical element driving mechanism is provided. The optical element driving mechanism includes a movable part, a fixed part, and a driving assembly. The movable part connects an optical element. The movable part is movable relative to the fixed part. The driving assembly drives the optical element to move relative to the fixed part.

According to certain aspects of the present disclosure, the driving assembly includes a first coil and a first magnetic element. The first coil has a long bar structure. The first coil includes a first section and a second section. The second section is parallel to the first section. The first magnetic element has a first magnetic element surface facing the first coil. The first coil and the first magnetic element are for driving the movable part to move along a first axis, and the first axis is perpendicular to the first magnetic element surface.

According to certain aspects of the present disclosure, when viewed along a direction perpendicular to the first magnetic element surface, the shortest distance between the first section and the center of the first magnetic element is different from the shortest distance between the second section and the center of the first magnetic element.

According to certain aspects of the present disclosure, the driving assembly further includes a second coil and a second magnetic element. The second coil has a long bar structure. The second coil includes a third section and a fourth section. The third section is parallel to the fourth section. The second magnetic element has a second magnetic element surface facing the second coil.

According to certain aspects of the present disclosure, when viewed along a direction perpendicular to the second magnetic element surface, the shortest distance between the third section and the center of the second magnetic element is different from the shortest distance between the fourth section and the center of the second magnetic element.

According to certain aspects of the present disclosure, the first magnetic element and the second magnetic element are arranged along a second axis. The second axis is perpendicular to the first axis.

According to certain aspects of the present disclosure, the first magnetic element surface and the second magnetic element surface face the same direction.

According to certain aspects of the present disclosure, the first section is parallel to the third section.

According to certain aspects of the present disclosure, when viewed along a direction perpendicular to the first magnetic element surface, the second section is located between the first section and the third section.

According to certain aspects of the present disclosure, when viewed along a direction perpendicular to the first magnetic element surface, the shortest distance between the third section and the center of the second magnetic element is less than the shortest distance between the fourth section and the center of the second magnetic element.

According to certain aspects of the present disclosure, the driving assembly further includes a third coil and a third magnetic element. The third magnetic element has a third magnetic element surface facing the third coil. The third coil and the third magnetic element are for driving the movable part to move along a third axis. The third axis is parallel to the third magnetic element surface.

According to certain aspects of the present disclosure, the first axis and the third axis are perpendicular to each other. The first axis is parallel to the third magnetic element surface. The third axis is parallel to the first magnetic element surface.

According to certain aspects of the present disclosure, the driving assembly further includes a fourth coil corresponding to the first magnetic element and the second magnetic element. The fourth coil and the first magnetic element are for driving the optical element to move along a fourth axis

According to certain aspects of the present disclosure, when viewed along a direction perpendicular to the first magnetic element surface, the fourth coil at least partially overlaps the first magnetic element.

According to certain aspects of the present disclosure, when viewed along a direction perpendicular to the first magnetic element surface, the first coil and the fourth coil at least partially overlap.

According to certain aspects of the present disclosure, when viewed along a direction perpendicular to the first magnetic element surface, the second coil and the fourth coil at least partially overlaps.

According to certain aspects of the present disclosure, the optical element driving mechanism further includes a position sensing assembly for sensing the movement of the optical element. The position sensing assembly has a first position sensing element for sensing the movement of the optical element along the fourth axis.

According to certain aspects of the present disclosure, the first position sensing element calculates the movement of the optical element by sensing the magnetic field of the third magnetic element.

According to certain aspects of the present disclosure, the position sensing component further includes a second position sensing element and a third position sensing element. The second position sensing element corresponds to the second magnetic element for sensing the movement of the optical element along the first axis. The third position sensing element corresponds to the third magnetic element for sensing the movement of the optical element along the third axis.

The above summary is not intended to represent each embodiment or every aspect of the present disclosure. Rather, the foregoing summary merely provides an example of some of the novel aspects and features set forth herein. The above features and advantages, and other features and advantages of the present disclosure, will be readily apparent from the following detailed description of representative embodiments and modes for carrying out the present invention, when taken in connection with the accompanying drawings and the appended claims. Additional aspects of the disclosure will be apparent to those of ordinary skill in the art in view of the detailed description of various embodiments, which is made with reference to the drawings, a brief description of which is provided below.

### BRIEF DESCRIPTION OF THE DRAWINGS

The disclosure, and its advantages and drawings, will be better understood from the following description of exemplary embodiments together with reference to the accompanying drawings. These drawings depict only exemplary embodiments, and are therefore not to be considered as limitations on the scope of the various embodiments or claims.

FIG. 1 is a front perspective view of an optical element driving mechanism and an optical element, according to certain aspects of the present disclosure.

FIG. 2 is an exploded perspective view of the optical element driving mechanism and the optical element according to certain aspects of the present disclosure.

FIG. 3 is a cross-sectional view of the optical element driving mechanism and the optical element along line A-A of FIG. 1, according to certain aspects of the present disclosure.

FIG. 4 is a bottom view of the optical element driving mechanism and the optical element, according to certain aspects of the present disclosure, wherein the fixed part is removed and the movable part is shown in dotted lines for illustrative purposes.

### DETAILED DESCRIPTION OF THE INVENTION

Various embodiments are described with reference to the attached figures, where like reference numerals are used throughout the figures to designate similar or equivalent elements. The figures are not necessarily drawn to scale and are provided merely to illustrate aspects and features of the present disclosure. Numerous specific details, relationships, and methods are set forth to provide a full understanding of certain aspects and features of the present disclosure, although one having ordinary skill in the relevant art will recognize that these aspects and features can be practiced without one or more of the specific details, with other relationships, or with other methods. In some instances, well-known structures or operations are not shown in detail for illustrative purposes. The various embodiments disclosed herein are not necessarily limited by the illustrated ordering of acts or events, as some acts may occur in different orders and/or concurrently with other acts or events. Furthermore, not all illustrated acts or events are necessarily required to implement certain aspects and features of the present disclosure.

For purposes of the present detailed description, unless specifically disclaimed, and where appropriate, the singular includes the plural and vice versa. The word “including” means “including without limitation.” Moreover, words of approximation, such as “about,” “almost,” “substantially,” “approximately,” and the like, can be used herein to mean “at,” “near,” “nearly at,” “within 3-5% of,” “within acceptable manufacturing tolerances of,” or any logical combination thereof. Similarly, terms “vertical” or “horizontal” are intended to additionally include “within 3-5% of” a vertical or horizontal orientation, respectively. Additionally, words of direction, such as “top,” “bottom,” “left,” “right,” “above,” and “below” are intended to relate to the equivalent direction as depicted in a reference illustration; as understood contextually from the object(s) or element(s) being referenced, such as from a commonly used position for the object(s) or element(s); or as otherwise described herein.

It will be understood that, although the terms “first”, “second”, etc. may be used herein to describe various elements, layers and/or parts, these elements, layers and/or parts should not be referred to as such. The terms are limited and are only used to distinguish between different elements, layers and/or parts. Thus, a first element, layer and/or part discussed below could be termed a second element, layer and/or part without departing from the teachings of some embodiments of the present disclosure. In addition, for the sake of simplicity, terms such as “first” and “second” may not be used to distinguish different elements in the specification. Without departing from the scope defined in the appended patent application, the first element and/or the second element described in the claims are interpreted as any element consistent with the description in the specification.

It should be noted that the technical solutions provided in different embodiments below may be replaced, combined or mixed with each other to constitute another embodiment without violating the spirit of the present disclosure.

The present disclosure relates to an optical element driving mechanism. The driving assembly has a plurality of coils and magnetic elements to drive the movable part and the optical element to move flexibly in various directions, thereby adjusting the photographic imaging of the optical element driving mechanism to adapt to different photography needs.

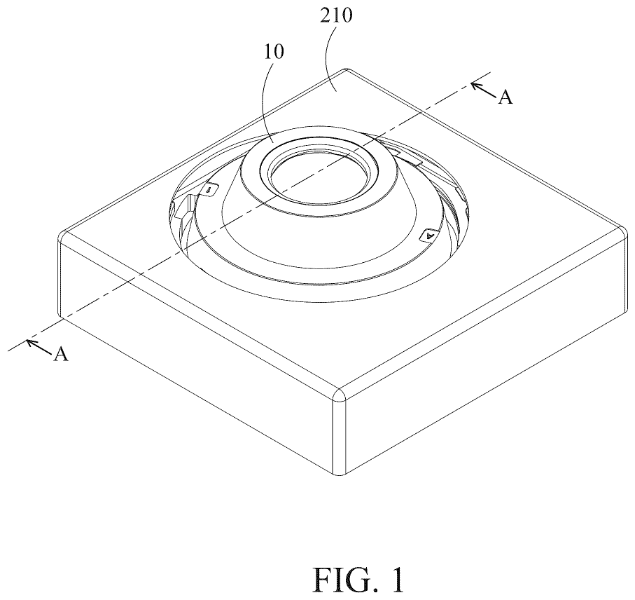

First, please refer to FIG. 1. FIG. 1 is a front perspective view of an optical element driving mechanism 1 and an optical element 10, according to certain aspects of the present disclosure.

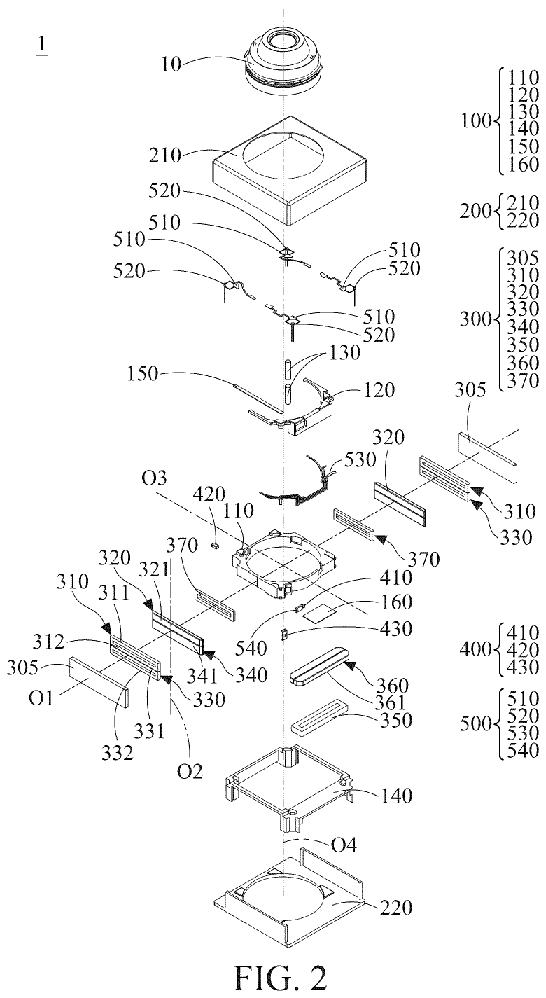

Please refer to FIG. 2. FIG. 2 is an exploded perspective view of the optical element driving mechanism 1 and the optical element 10, according to certain aspects of the present disclosure. The optical element driving mechanism 1 includes a movable part 100, a fixed part 200, a driving assembly 300, a position sensing assembly 400, and a circuit assembly 500. The movable part 100 is connected to the optical element 10, and the optical element 10 may be, for example, an optical lens. The movable part 100 may move relative to the fixed part 200, and the driving assembly 300 drives the optical element 10 to move relative to the fixed part 200. The position sensing assembly 400 is for sensing the movement of the optical element 10.

The movable part 100 includes a first movable part 110, a second movable part 120, two guide rods 130, a frame 140, and two magnetic permeable plates 150 and 160.

The movable part 100 accommodates the optical element 10. A circuit element 530 of the circuit assembly 500 is embedded between the first movable part 110 and the second movable part 120. The first movable part 110 contacts the frame 140 through two guide rods 130, so the first movable part 110, the second movable part 120, and the optical element 10 may move relative to the frame 140 (as will be described in detail below with respect to the driving assembly 300). The two magnetic permeable plates 150 and 160 are respectively located above a first magnetic element 320 and a third magnetic element 360 of the driving assembly 300, which may prevent magnetic field interference between multiple sets of magnetic elements.

The fixed part 200 includes a housing 210 and a base 220. The housing 210 is fixedly connected to the base 220 to accommodate other components of the optical element driving mechanism 1 and the optical element 10.

The driving assembly 300 includes two flat plates 305, two first coils 310, two first magnetic elements 320, two second coils 330, two second magnetic elements 340, a third coil 350, a third magnetic element 360, and two fourth coils 370. The first coil 310 and the second coil 330 are embedded in the flat plate 305 to form a set of flat plate coils.

A first coil 310, a first magnetic element 320, a second coil 330, a second magnetic element 340, and a fourth coil 370 form a group and are respectively arranged on opposite sides of the movable part 100. Only one side of the arrangement of the movable part 100 is described below, and the coils and magnetic elements on the other side are arranged in the same manner.

The first coil 310 is disposed on the base 220 of the fixed part 200 and includes a first section 311 and a second section 312. The first section 311 and the second section 312 have a long bar structure. The second section 312 is parallel to the first section 311.

The first magnetic element 320 is disposed on the frame 140 and has a first magnetic element surface 321, and the first magnetic element surface 321 faces the first coil 310.

By the electromagnetic driving force generated between the first magnetic element 320 and the first coil 310, the first magnetic element 320 moves relative to the first coil 310, thereby driving the frame 140 to move relative to the base 220. The frame 140 drives the first movable part 110, the second movable part 120, and the optical element 10 to move. Therefore, the electromagnetic driving force generated between the first magnetic element 320 and the first coil 310 may drive the movable part 100 to move relative to the fixed part 200.

The first coil 310 and the first magnetic element 320 drive the movable part 100 to move along a first axis O1, and the first axis O1 is perpendicular to the first magnetic element surface 321.

The second coil 330 is disposed on the base 220 of the fixed part 200 and includes a third section 331 and a fourth section 332. The third section 331 and the fourth section 332 have a long bar structure. The third section 331 is parallel to the fourth section 332.

The second magnetic element 340 is disposed on the frame 140 and has a second magnetic element surface 341, and the second magnetic element surface 341 faces the second coil 330.

The first magnetic element 320 and the second magnetic element 340 are arranged along a second axis O2. The second axis O2 is perpendicular to the first axis O1. The first magnetic element surface 321 and the second magnetic element surface 341 face the same direction. The first section 311 is parallel to the third section 331.

By the electromagnetic driving force generated between the second magnetic element 340 and the second coil 330, the second magnetic element 340 moves relative to the second coil 330, thereby driving the frame 140 to move relative to the base 220. The frame 140 drives the first movable part 110, the second movable part 120, and the optical element 10 to move. Therefore, the electromagnetic driving force generated between the second magnetic element 340 and the second coil 330 may drive the movable part 100 to move along the first axis O1 relative to the fixed part 200.

The third coil 350 is disposed on the base 220 of the fixed part 200.

The third magnetic element 360 is disposed on the frame 140 and has a third magnetic element surface 361, and the third magnetic element surface 361 faces the third coil 350.

By the electromagnetic driving force generated between the third magnetic element 360 and the third coil 350, the third magnetic element 360 moves relative to the third coil 350, thereby driving the frame 140 to move relative to the base 220. The frame 140 drives the first movable part 110, the second movable part 120, and the optical element 10 to move. Therefore, the electromagnetic driving force generated between the third magnetic element 360 and the third coil 350 may drive the movable part 100 to move relative to the fixed part 200.

The third coil 350 and the third magnetic element 360 drive the movable part 100 to move along a third axis O3, and the third axis O3 is parallel to the surface 361 of the third magnetic element 360.

The first axis O1 and the third axis O3 are perpendicular to each other. The first axis O1 is parallel to the third magnetic element surface 361. The third axis O3 is parallel to the first magnetic element surface 321.

The fourth coil 370 is disposed on the first movable part 110 of the movable part 100, corresponding to the first magnetic element 320 and the second magnetic element 340.

By the electromagnetic driving force generated between the first magnetic element 320 and the fourth coil 370, the first magnetic element 320 moves relative to the fourth coil 370, thereby driving the frame 140 to move relative to the base 220. The frame 140 drives the first movable part 110, the second movable part 120, and the optical element 10 to move. Therefore, the movable part 100 may be driven to move relative to the fixed part 200 by the electromagnetic driving force generated between the first magnetic element 320 and the fourth coil 370.

The fourth coil 370 and the first magnetic element 320 drive the optical element 10 and the movable part 100 to move along a fourth axis O4. The first movable part 110 contacts the frame 140 through the two guide rods 130, so the first movable part 110, the second movable part 120, and the optical element 10 may move relative to the frame 140 along the fourth axis O4.

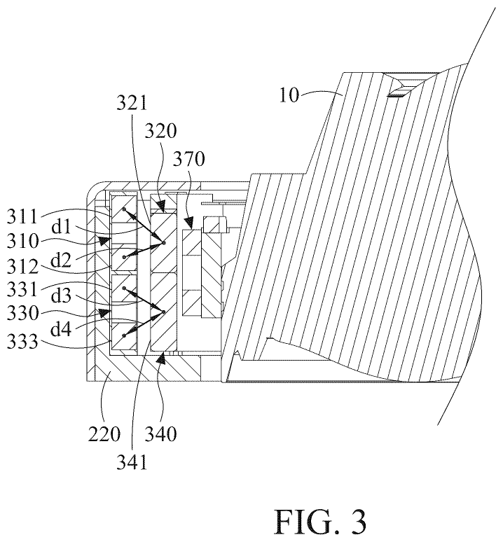

Please see FIG. 3 next. FIG. 3 is a cross-sectional view of the optical element driving mechanism 1 and the optical element 10 along line A-A of FIG. 1, according to certain aspects of the present disclosure.

When viewed along the direction of the first magnetic element surface 321 (that is, when viewed along the direction of the second magnetic element surface 341), the shortest distance d1 between the first section 311 and the center of the first magnetic element 320 is different from the shortest distance d2 between the second section 312 and the center of the first magnetic element 320.

When viewed along the direction of the first magnetic element surface 321 (that is, when viewed along the direction of the second magnetic element surface 341), the shortest distance d3 between the third section 331 and the center of the second magnetic element 340 is different from the shortest distance d4 between the fourth section 332 and the center of the second magnetic element 340.

When viewed along the direction of the first magnetic element surface 321 (that is, when viewed along the direction of the second magnetic element surface 341), the second section 312 is located between the first section 311 and the third section 331. The shortest distance d1 between the first section 311 and the center of the first magnetic element 320 is greater than the shortest distance d2 between the second section 312 and the center of the first magnetic element 320. The shortest distance d3 between the third section 331 and the center of the second magnetic element 340 is smaller than the shortest distance d4 between the fourth section 332 and the center of the second magnetic element 340.

When viewed along the normal vector direction of the first magnetic element surface 321 or the second magnetic element surface 341, the fourth coil 370 at least partially overlaps the first magnetic element 320. The first coil 310 and the fourth coil 370 at least partially overlap, and the second coil 330 and the fourth coil 370 at least partially overlap.

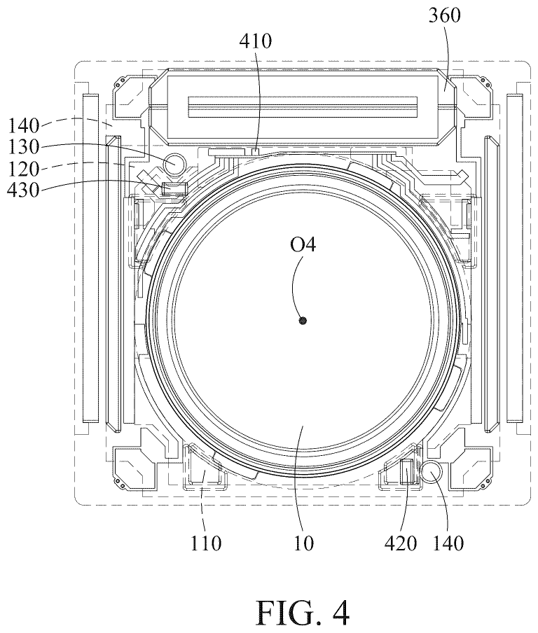

Next, please continue to refer to FIG. 2 and FIG. 4. FIG. 4 is a bottom view of the optical element driving mechanism 1 and the optical element 10, according to certain aspects of the present disclosure. For illustrative purposes, the fixed part 200 is removed and the movable part 100 is shown in dotted line.

The position sensing assembly 400 includes a first position sensing element 410, a second position sensing element 420, and a third position sensing element 430.

The first position sensing element 410 is disposed on the second movable part 120 for sensing the movement of the optical element 10 along the fourth axis O4. The first position sensing element 410 calculates the movement of the optical element 10 by sensing the magnetic field of the third magnetic element 360.

The second position sensing element 420 is disposed on the first movable part 110. As shown in FIG. 4, the second position sensing element 420 is embedded in the first movable part 110 and corresponds to the second magnetic element 340 for sensing the movement of the optical element 10 on the first axis O1.

The third position sensing element 430 is disposed on the first movable part 110. As shown in FIG. 4, the third position sensing element 430 is embedded in the first movable part 110 and corresponds to the third magnetic element 360 for sensing the movement of the sensing optical element 10 on the third axis O3.

Next, please continue to refer to FIG. 2. The circuit assembly 500 includes four elastic elements 510, four connecting elements 520, a circuit element 530, and a control circuit 540.

The position signal sensed by the position sensing assembly 400 may be transmitted to the control circuit 540 through the circuit element 530 and the elastic element 510, and the control signal is transmitted from the control circuit 540 through the circuit element 530, the elastic element 510, and the connecting element 520 to the driving assembly 300.

In summary, the present invention provides an optical element driving mechanism, including a movable part, a fixed part, a driving assembly, a position sensing assembly, and an circuit assembly. The movement of the driving assembly drives the movable part to move relative to the fixed part. With this, the position of the optical element may be adjusted to adapt to different external photography needs. At the same time, the multiple sets of coils and magnetic elements of the driving assembly may effectively provide sufficient driving force, bear the weight of the movable part, stabilize the internal structure, reduce operating failures of the driving assembly during operation, and provide optical quality that is better and more stable.

Although the disclosed embodiments have been illustrated and described with respect to one or more implementations, equivalent alterations and modifications will occur or be known to others skilled in the art upon the reading and understanding of this specification and the annexed drawings. In addition, while a particular feature of the invention may have been disclosed with respect to only one of several implementations, such feature may be combined with one or more other features of the other implementations as may be desired and advantageous for any given or particular application.

While various embodiments of the present invention have been described above, it should be understood that they have been presented by way of example only, and not limitation. Numerous changes to the disclosed embodiments can be made, according to the disclosure herein, without departing from the spirit or scope of the invention. Thus, the breadth and scope of the present invention should not be limited by any of the above described embodiments. Rather, the scope of the invention should be defined, according to the following claims and their equivalents.

The terminology used herein is for the purpose of describing particular embodiments only and is not intended to be limiting of the invention. As used herein, the singular forms “a, an” and “the” are intended to include the plural forms as well, unless the context clearly indicates otherwise. In addition, the terms “including, includes”, “having, has, with” or variations thereof used in the embodiments and/or claims are intended to be similar to “comprising” is included.

What is claimed is:

1. An optical element driving mechanism, comprising:
a movable part for connecting an optical element;
a fixed part, wherein the movable part is moveable relative to the fixed part; and
a driving assembly, driving the optical element to move relative to the fixed part.

2. The optical element driving mechanism as claimed in claim 1, wherein the driving assembly includes:
a first coil, having a long bar structure, wherein the first coil includes a first section and a second section, and the second section is parallel to the first section; and
a first magnetic element, having a first magnetic element surface facing the first coil;
wherein the first coil and the first magnetic element are for driving the movable part to move along a first axis, and the first axis is perpendicular to the first magnetic element surface.

3. The optical element driving mechanism as claimed in claim 2, wherein when viewed along a direction perpendicular to the first magnetic element surface, the shortest distance between the first section and the center of the first magnetic element is different from the shortest distance between the second section and the center of the first magnetic element.

4. The optical element driving mechanism as claimed in claim 2, wherein when viewed along a direction perpendicular to the first magnetic element surface, the shortest distance between the first section and the center of the first magnetic element is larger than the shortest distance between the second section and the center of the first magnetic element.

5. The optical element driving mechanism as claimed in claim 2, wherein the driving assembly further includes:
a second coil, having a long bar structure, wherein the second coil includes a third section and a fourth section, and the third section is parallel to the fourth section; and
a second magnetic element, having a second magnetic element surface facing the second coil.

6. The optical element driving mechanism as claimed in claim 5, wherein when viewed along a direction perpendicular to the second magnetic element surface, the shortest distance between the third section and the center of the second magnetic element is different from the shortest distance between the fourth section and the center of the second magnetic element.

7. The optical element driving mechanism as claimed in claim 5, wherein the first magnetic element and the second magnetic element are arranged along a second axis, and the second axis is perpendicular to the first axis.

8. The optical element driving mechanism as claimed in claim 5, wherein the first magnetic element surface and the second magnetic element surface face the same direction.

9. The optical element driving mechanism as claimed in claim 5, wherein the first section is parallel to the third section.

10. The optical element driving mechanism as claimed in claim 5, wherein when viewed along a direction perpendicular to the first magnetic element surface, the second section is located between the first section and the third section.

11. The optical element driving mechanism as claimed in claim 5, wherein when viewed along a direction perpendicular to the first magnetic element surface, the shortest distance between the third section and the center of the second magnetic element is less than the shortest distance between the fourth section and the center of the second magnetic element.

12. The optical element driving mechanism as claimed in claim 5, wherein the driving assembly further includes:
a third coil; and
a third magnetic element, having a third magnetic element surface facing the third coil;
the third coil and the third magnetic element are for driving the movable part to move along a third axis, and the third axis is parallel to the third magnetic element surface.

13. The optical element driving mechanism as claimed in claim 12, wherein:
the first axis and the third axis are perpendicular to each other;
the first axis is parallel to the third magnetic element surface;
the third axis is parallel to the first magnetic element surface.

14. The optical element driving mechanism as claimed in claim 12, wherein the driving assembly further includes:
a fourth coil, corresponding to the first magnetic element and the second magnetic element, wherein
the fourth coil and the first magnetic element are for driving the optical element to move along a fourth axis.

15. The optical element driving mechanism as claimed in claim 14, wherein when viewed along a direction perpendicular to the first magnetic element surface, the fourth coil at least partially overlaps the first magnetic element.

16. The optical element driving mechanism according to claim 14, wherein when viewed along a direction perpendicular to the first magnetic element surface, the first coil and the fourth coil at least partially overlap.

17. The optical element driving mechanism according to claim 14, wherein when viewed along a direction perpendicular to the first magnetic element surface, the second coil and the fourth coil at least partially overlap.

18. The optical element driving mechanism as claimed in claim 14, further comprising a position sensing assembly for sensing the movement of the optical element, wherein the position sensing assembly has a first position sensing element for sensing the movement of the optical element along the fourth axis.

19. The optical element driving mechanism as claimed in claim 18, wherein the first position sensing element calculates the movement of the optical element by sensing the magnetic field of the third magnetic element.

20. The optical element driving mechanism as claimed in claim 18, wherein the position sensing assembly further includes:
a second position sensing element, corresponding to the second magnetic element for sensing the movement of the optical element along the first axis; and
a third position sensing element, corresponding to the third magnetic element for sensing the movement of the optical element along the third axis.
